(19) United States
(12) Patent Application Publication
(10) Pub. No.: US 2024/0156677 A1
(43) Pub. Date: May 16, 2024

(54) HYBRID SPA

(71) Applicant: Sundance Spas, Inc., Chino, CA (US)

(72) Inventors: Larry R. Ovalle, Glendora, CA (US); Erica A. Langpeter Moir, Santa Ana, CA (US); Brian Pierson, Beaverton, OR (US)

(21) Appl. No.: 18/506,531

(22) Filed: Nov. 10, 2023

Related U.S. Application Data
(60) Provisional application No. 63/383,471, filed on Nov. 11, 2022.

(51) Int. Cl. A61H 33/00

(52) U.S. Cl. CPC A61H 33/0087; A61H 33/0095; A61H 2201/0207; A61H 2201/5007

(57) ABSTRACT

A hybrid spa has a power adapter connected to a 120 V outlet, a battery connected to the power adapter, and a plurality of spa components connected to the power adapter and the battery. The plurality of components includes a jet pump, a circulation pump, a main heater, and a controller. The battery powers at least some of the plurality of spa components and the power adapter powers the rest. The hybrid spa can further include a secondary heater connected to the battery and a power outlet. The secondary heater can assist the main heater when water needs to be heated by more than 5° F.

### CROSS-REFERENCE TO RELATED APPLICATIONS

This application claims the benefit of U.S. Provisional Application No. 63/383,471, entitled “HYBRID SPA” and filed on Nov. 11, 2022, which is hereby incorporated by reference herein in its entirety.

### TECHNICAL FIELD

The present invention relates generally to a hybrid spa unit or hot tub.

### BACKGROUND

Most conventional spa units or hot tubs require a 240 V installation to allow the spa unit and its components to operate simultaneously. A 240 V power outlet installation can be expensive. A conventional 120 V power outlet, on the other hand, may not be capable of handling the power demands of a spa unit, may result in lengthy heating periods, or prevent users from operating the spa when two or more spa components are operating simultaneously.

### SUMMARY

The hybrid spa units or hot tubs described herein can include a rechargeable battery that can power one or more components of the spa unit or hot tub. The rechargeable battery allows users to operate the spa unit or hot tub and its components using a conventional 120 V power outlet. Some embodiments include a main heater and secondary heater. The hybrid spa can be used without sacrificing the ability to use two or more spa components simultaneously, such as a pump and a heater, and can heat water from tap temperature more rapidly.

Disclosed herein is a hybrid spa. The hybrid spa can include a housing, a rechargeable battery, and a plurality of spa components. The rechargeable battery can be configured to be connected to a first power outlet and/or the battery. Each of the plurality of spa components can be configured to draw power from the first power outlet and/or the battery. The battery can be configured to recharge by drawing power from the first power outlet when the plurality of spa components are not in use.

In some cases, each of the plurality of spa components can be configured to draw power from only one of the first power outlet or the battery. However, each of the plurality of spa components can be configured to draw power from the first power outlet and the battery. Each of the plurality of spa components can configured to draw power at least from the first power outlet. The battery can comprise a charger, a battery pack for storing power, and an inverter. The inverter can convert direct current (DC) to alternating current (AC). In some cases, the plurality of spa components can comprise a jet pump, a circulation pump, and/or a main heater. Each of the jet pump, the circulation pump, and the main heater can be configured to draw power at least from the first power outlet. The hybrid spa can include a main heater and a secondary heater. The main heater can be configured to draw power from the first power outlet and the secondary heater can be configured to be connected to a second power outlet. The hybrid spa can include a controller. The controller can be configured to manage power distribution to the plurality of spa components. In some cases, the controller can be configured to activate both the main heater and the secondary heater when heating water by more than 5° F. The hybrid spa can include an equipment bay within a footprint of the housing. In some cases, the battery can be positioned in the equipment bay. A plurality of panels can cover the equipment bay.

The plurality of spa components can comprise a first component and a second component. In some cases, at least one of the first component or the second component can be connected to a second power source to draw power from the second power source when a combined power requirement of the first and second components is likely to exceed or about to exceed a maximum load of the first power outlet. The first and second components can be configured to draw power from the first power outlet and/or battery when the combined power requirement of the first and second of components is not likely to exceed the maximum load of the first power outlet. The hybrid spa may include a controller to manage power distribution to the plurality of spa components. The controller may be configured to determine when a combined power requirement of the first and second components is likely to exceed a maximum load of the first power outlet based on known power requirements of the first and second components compared to a maximum load of the first power outlet. The controller may be configured to determine whether a combined power requirement of the first and second components is about to exceed a maximum load of the first power outlet by measuring the power drawn by the first and second components, in use, compared to a maximum load of the first power outlet.

The first component can comprise a main heater. In some cases, the second component can comprise a secondary heater. The combined power requirement of the first and second heaters may exceed the maximum load of the first power outlet when heating a starting temperature of water by at least 5° F.

A first spa component can be configured to draw power from the first power outlet. In some cases, a second spa component can be configured to draw power from the battery when a combined power requirement of the first and second components is likely to exceed or about to exceed a maximum load of the first power outlet.

The maximum load can comprise at least 1800 watts. In some cases, the maximum load can comprise at least 2400 watts, and/or at least 3600 watts.

In some cases, the rechargeable battery and the plurality of spa components can be connected to the first power outlet via a power adapter.

In some variants, a hybrid spa can comprise a battery, a heater, and a plurality of jet pumps. In some cases, the battery and the heater can be configured to be connected to the first power outlet. The plurality of jet pumps can be connected to the first power outlet and the battery. The heater can be configured to draw power from the first power outlet. In some cases, the plurality of jet pumps can be configured to draw power from the battery when both the heater and the plurality of jet pumps are in use.

The hybrid spa can include a controller configured to manage power distribution to the heater and the plurality of jet pumps. The hybrid spa can comprise a secondary heater connected to a second power outlet. The controller can be configured to activate both the heater and the secondary heater when heating water by more than 5° F. In some cases, the battery can recharge when the heater and the plurality of jet pumps are not in use.

The hybrid spa can include a housing and an equipment bay within a footprint of the housing. The battery can be positioned in the equipment bay. In some cases, the hybrid spa can comprise a plurality of insulation panels covering the equipment bay.

In some cases, the battery, the heater, and the plurality of jet pumps can be connected to the first power outlet via a power adapter.

A method of operating a hybrid spa can include the steps of connecting a battery to a first power outlet; powering a main heater using the first power outlet; powering a plurality of spa jets using the battery; and charging the battery by drawing power from the first power outlet when the heater and the spa jets are not in use.

In some cases, the method of operating the hybrid spa can comprise powering a secondary heater using a second power outlet. The method can comprise using the main heater and the secondary heater to heat a starting temperature of water by at least 5° F. In some cases, the first power outlet can comprise a 120 V power outlet. Connecting the battery to the first power outlet can comprise connecting the battery to the first power outlet via a power adapter.

A hybrid spa can comprise a main heater and a secondary heater. The main heater can be connected to a first power outlet and the second heater can be connected to a second power outlet. In some cases, the first and second heaters can be configured to operate simultaneously when heating water by more than a predetermined temperature change, for example more than 5° F.

An electrical system for a spa, such as any of the hybrid spas described herein, can include a battery, and at least one spa component. In some cases, the battery can be configured to be connected to the first power outlet. The at least one spa component can be configured to be connected to the first power outlet and/or the battery and be configured to draw power from the first power outlet and/or the battery. The battery can be configured to recharge by drawing power from the first power outlet when the at least one spa component is not in use.

In some variants, the at least one spa component comprises one of a jet pump, a circulation pump, and/or a main heater. The at least one spa component can comprise a first spa component and a second spa component. At least one of the first or second spa components can be connected to a second power source to draw power from the second power source when a combined power requirement of the first and second spa components is likely to exceed or about to exceed a maximum load of the first power outlet. The first and second spa components can be configured to draw power from the first power outlet and/or the battery when the combined power requirement of the first and second spa components is not likely to exceed the maximum load of the first power outlet. In some cases, the maximum load can comprise at least 1800 watts. The maximum load can comprise at least 2400 watts, and/or at least 3600 watts. The first spa component can comprise a main heater and the second spa component can comprise a secondary heater. The combined power requirement of the first and second heaters may exceed the maximum load of the first power outlet when heating water by more than a predetermined temperature change, for example 5° F. In some cases, the battery and the least one spa component can be connected to the first power outlet via a power adapter.

A method of operating a hybrid spa can comprise connecting a battery to a first power outlet; powering a first spa component using the first power outlet or the battery; powering a second spa component using the first power outlet or the battery; and charging the battery by drawing power from the first power outlet when the first and second spa components are not in use.

In some cases, the method can comprise powering the second spa component using a second power outlet when a combined power requirement of the first and second spa components is likely to exceed or about to exceed a maximum load of the first power outlet. The combined power requirement of the first and second spa components may exceed the maximum load of the first power outlet when heating water by more than a predetermined temperature change, for example more than 5° F. The method can comprise powering the first spa component using the first power outlet and powering the second spa component using the battery.

In some cases, the method can comprise powering the first and second spa components using the first power outlet or the battery when the combined power requirement of the first and second spa components does not exceed the maximum load of the first power outlet. In some cases, connecting the battery to the first power outlet can comprise connecting the battery to the first power outlet via a power adapter.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1A shows a schematic view of an example embodiment of a hybrid spa.

FIG. 1B shows an example of a hybrid spa including an equipment bay.

FIG. 1C shows an example of a hybrid spa including a plurality of insulation panels covering the equipment bay.

FIG. 2 shows an example of another embodiment of a hybrid spa.

FIG. 3 shows a schematic view of a battery system for a hybrid spa.

### DETAILED DESCRIPTION

Hybrid spas and/or hot tubs and components thereof are described herein. The hybrid spas can include a power adapter and/or a battery for powering one or more spa components. Depending on the combined power requirement of the one or more spa components, the one or more spa components may draw power from the same power source and/or different power sources. For example, when using two or more or spa components whose combined power requirement exceeds that of a standard 120V power outlet, the hybrid spa can cause a first spa component to draw power from a first power source (e.g., a first power outlet) and a second spa component to draw power from a second power source (e.g., a second power outlet and/or a battery). This can beneficially allow the hybrid spa to be installed and operated in locations where access to a 240V power outlet is not available and/or prevent the spa components from overloading a single power outlet, which can result in damage to the spa and its components and/or a fire.

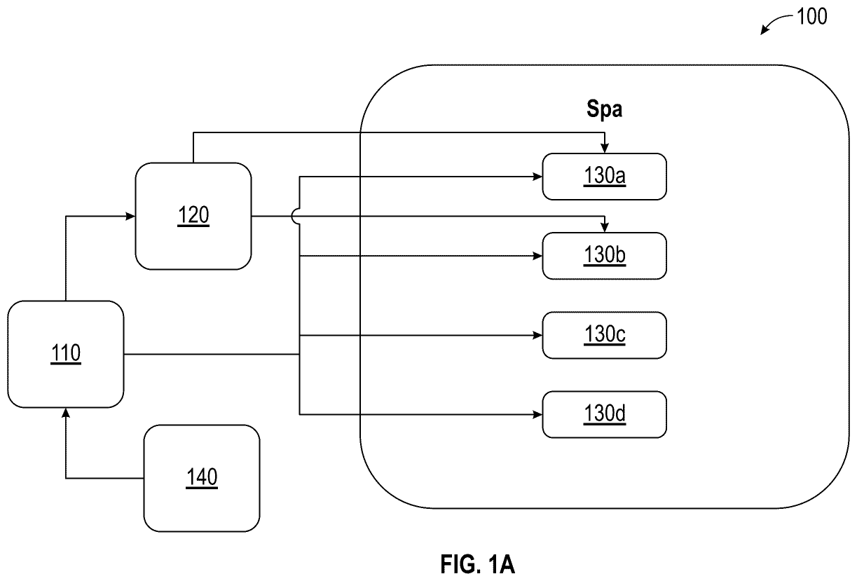

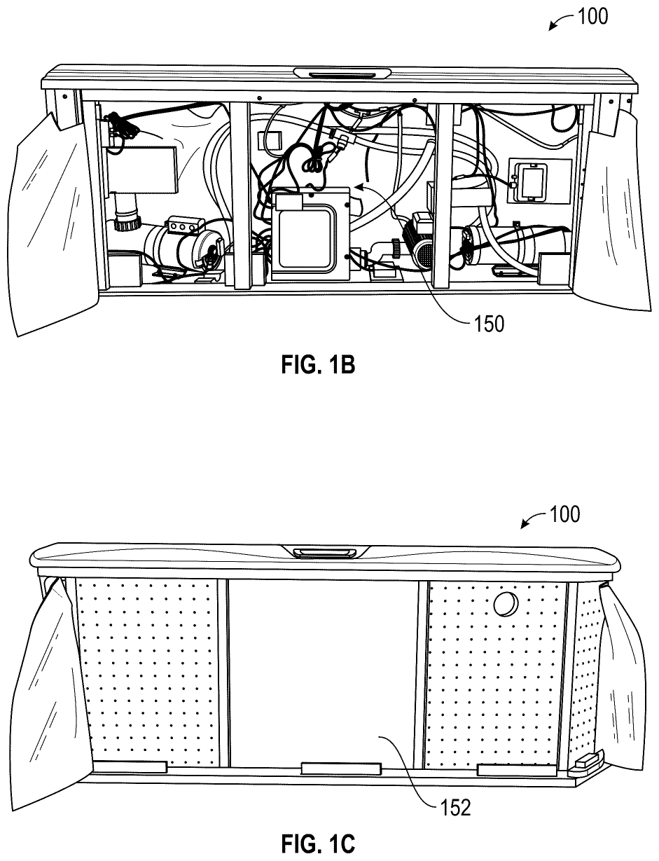

FIG. 1A shows a schematic view of a hybrid spa 100 that can be plugged into, for example, conventional 120V, 15-30 amp power outlets. In some cases, the hybrid spa 100 can include a power adapter 110 and one or more batteries 120. The power adapter 110 (via a power outlet or other power source) and the battery 120 can power one or more spa components of the hybrid spa 100. The spa components can include one or more jet pump(s) 130a, circulation pump(s) 130b, heater(s) 130c, and/or controller(s) 130d. Although certain spa components may be referred to or illustrated in singular form below, there may also be a plurality of any of the described spa components. The power adapter 110 and the battery 120 can be plugged to, for example, conventional 120 V, 15-30 amp power outlets (e.g., 20 amps). For example, the power adapter 110 can be plugged to a power outlet 140. The power adapter 110 can distribute power from the power outlet 140 to the plurality of spa components and the battery 120. In some cases, the power adapter 110 can be plugged to a first power outlet 140 and the battery 120 can be plugged to a second power outlet. The battery 120 and the spa components can draw power from the power adapter 110. Beneficially, the hybrid spa 100 can be installed in any location having at least one 120 V power outlet and does not require a specialized 240 V power outlet installation. In some cases, the plurality of spa components can be connected directly to the first power outlet 140 and draw power directly from the first power outlet 140.

The power adapter 110 optionally includes a transformer to convert the voltage and/or current of a signal originating from a power outlet to a lower (or higher) voltage and/or current and/or to convert the frequency of the signal originating from the power outlet to a different frequency, a rectifier and/or filter to convert the alternating current (AC) signal originating from the power outlet into a direct current (DC) signal, and/or the like. In other words, the power adapter 110 may change the voltage, current, frequency, and/or type of signal originating from a power outlet to, for example, conform to the requirements of a particular spa component.

In any of the embodiments described herein, each of the spa components 130a-130d can be connected to at least one power source (e.g., power adapter 110, the battery 120, and/or a second power adapter). Depending on the combined power requirement of the spa components 130a-130d, two or more of the spa components 130a-130d may draw power from different power sources. When, for example, the combined power requirement of a first spa component (e.g., a jet pump 130a) and a second spa component (e.g., a heater 130c) exceeds a maximum load of a single power source, the first and second spa components may draw power from different power sources. For instance, the first spa component (e.g., a jet pump 130a) can draw power from the power adapter 110 while the second spa component (e.g., a heater 130c) draws power from the battery 120. This can allow the combined power requirement of the spa components 130a-130d to be drawn from more than one source of power. This can beneficially prevent the spa components 130a-130d from overloading a single source of power.

In some cases, each spa component may draw power from a different power source. Before the combined power requirement of two or more spa components exceeds the maximum load of a single power source, the spa component may draw power from the same power source. When the combined power requirement of the two or more spa components exceeds, or is about to exceed the maximum load of a single power source (e.g., when it is 1%, 2%, 3%, 4%, 5%, 10%, 15%, etc. from exceeding the maximum power load of a single power source), at least one spa component may switch from one power source to another power source.

In operation, the battery 120 can be recharged by drawing power from the power adapter 110. In some cases, the battery 120 can draw power from the power adapter 110 when, for example, none of the spa components are in use. In operation, the power adapter 110 and/or the battery 120 can supply power to any of the spa components. Additionally or alternatively, the battery 120 can recharged by drawing power from an alternative source of power, such as a solar panel. The solar panel can also power the spa components. The power adapter 110 can supply power to the jet pump 130a, the circulation pump 130b, the heater 130c, and the controller 130d. In some cases, the battery 120 can supply power to the jet pump 130a and/or the circulation pump 130b. In some cases, the power adapter 110 and the battery 120 can supply power to the same spa components simultaneously.

The use of the battery 120 for powering at least some of the spa components can beneficially prevent the hybrid spa 100 from overloading a single power outlet (120 V power outlet). For example, the power necessary to simultaneously power all the spa components (also referred herein as combined power requirement) may overload a maximum load or capacity of a standard 120 V power outlet and cause the spa 100 to shut down and/or result in a fire. In some cases, a 120 V outlet may have maximum capacity of about 1400 watts, 1800 watts, 2000 watts, 2400 watts and/or 3600 watts. The load on the power outlet by the spa components can be reduced by powering at least a subset of the spa components with the battery 120. For example, a charged battery 120 can power the one or more jet pumps 130a and/or the circulation pump 130b while the power adapter 110 can power the heater 130c and the spa controller 130d. This can prevent the power adapter 110 from overloading the power outlet 140 and allow a user to operate the jet pump 130a, the circulation pump 130b, and the heater 130c simultaneously.

The battery 120 can include different capacities (also referred to as energy ratings) and power ratings. For example, the battery 120 can have a capacity of or about 800 Wh, 1600 Wh, and 2400 Wh, and a power rating of or about 2400 W continuous draw (for spas including a 240V configuration) and 1600 W continuous draw (for spas including a 120V configuration). In some cases, the battery 120 can include a Lithium Iron Phosphate (LFP) battery. An 800 Wh battery 120 can power the jet pumps 130a or circulation pumps 130b for about twenty minutes. A 1600 Wh battery 120 can power the jet pumps 130a or circulation pumps 130b for about forty minutes. A 2400 Wh battery 120 can power the jet pumps 130a or circulation pumps 130b for about sixty minutes. The battery 120 can be positioned inside an equipment bay 150 of the spa 100, as shown in FIG. 1B, or in an external housing, and have an operating temperature ranging from about −40° F. to about 130° F. (−40° C. to 55° C.). One or more insulation panels 152 can cover the equipment bay 150 thereby insulating the equipment bay 150, as shown in FIG. 1C.

The controller 130d can manage the power distribution of the spa components. The controller 130d can, in some cases, detect and/or anticipate a power overload and cause the spa components to draw power from a different power source. For example, using the heater 130c and the jet pumps 130a can cause the spa 100 to overload a conventional 120 V power outlet, such as power outlet 140. To prevent a power overload, the controller 130d can cause the jet pumps 130a, or any other spa component, to stop drawing power from the power adapter 110 and start drawing power from the battery 120. This can beneficially reduce the power drawn by the spa from the power outlet 140, preventing a circuit overload when the heater 130c and other components of the spa 100 are operating simultaneously. The controller 130d can cause the one or more spa components to alternate between different sources of power (e.g., the power adapter 110 and/or the battery 120) as needed.

For example, the controller 130d may be preconfigured to automatically cause a second (or third, fourth, fifth, etc.) spa component to begin drawing power from a secondary power source (e.g., battery 120, a second power outlet, etc.) if the controller 130d detects or determines that a first spa component is already drawing power from a primary power source (e.g., the power outlet 140). In this example, the controller 130d may have previously activated a first spa component or previously received an indication that a first spa component is active and/or previously determined that the first spa component is drawing power from a primary power source. If the controller 130d determines or receives an instruction to activate a second spa component, the controller 130d may activate the second spa component with an instruction to draw power from a secondary power source. As used herein, the controller 130d instructing a spa component to draw power from a primary power source or a secondary power source can include the controller 130d transmitting a signal or instruction that causes the spa component to draw power from the identified power source, the controller 130d causing a switch or other electronic circuit to direct power to the spa component that originates from the identified power source, and/or the like. Thus, the second spa component may not draw power from the primary power source when initially activated, thereby avoiding a potential power overload. If the controller 130d later determines or receives an instruction to deactivate the first spa component, then the controller 130d can deactivate the first spa component. Once deactivated, the controller 130d can optionally instruct the second spa component to begin drawing power from the primary power source instead of the secondary power source. If the controller 130d subsequently determines or receives an instruction to activate the first spa component or a third spa component, the controller 130d can either activate the corresponding spa component and instruct the spa component to draw power from a secondary power source or the controller 130d can instruct the spa component to draw power from the primary power source and instruct the second spa component to begin drawing power from a secondary power source instead of the primary power source. This process can be repeated for any number of spa components, where the controller 130d may instruct one active spa component to draw power from a primary power source and may instruct other active spa component(s) to draw power from a secondary power source. Optionally, the controller 130d may allow multiple spa components to draw power from a primary power source if, for example, the power drawn by these spa components (as detected by the controller 130d via one or more electrical circuits or determined by the controller 130d via preconfigured data identifying the typical power drawn by each of the spa components) does not exceed the maximum power load of the primary power source.

Alternatively or in addition, the controller 130d may include electrical circuits that can be used to detect voltage, current, and/or power draw from one or more spa components. If the controller 130d detects that the voltage, current, and/or power collectively drawn by active spa component(s) exceeds the maximum voltage, current, and/or power load of a primary power source (e.g., the power outlet 140), the controller 130d can instruct one or more spa components to begin drawing power from a secondary power source instead of the primary power source until the detected voltage, current, and/or power collectively drawn by active spa component(s) from the primary power source no longer exceeds the maximum voltage, current, and/or power load of the primary power source.

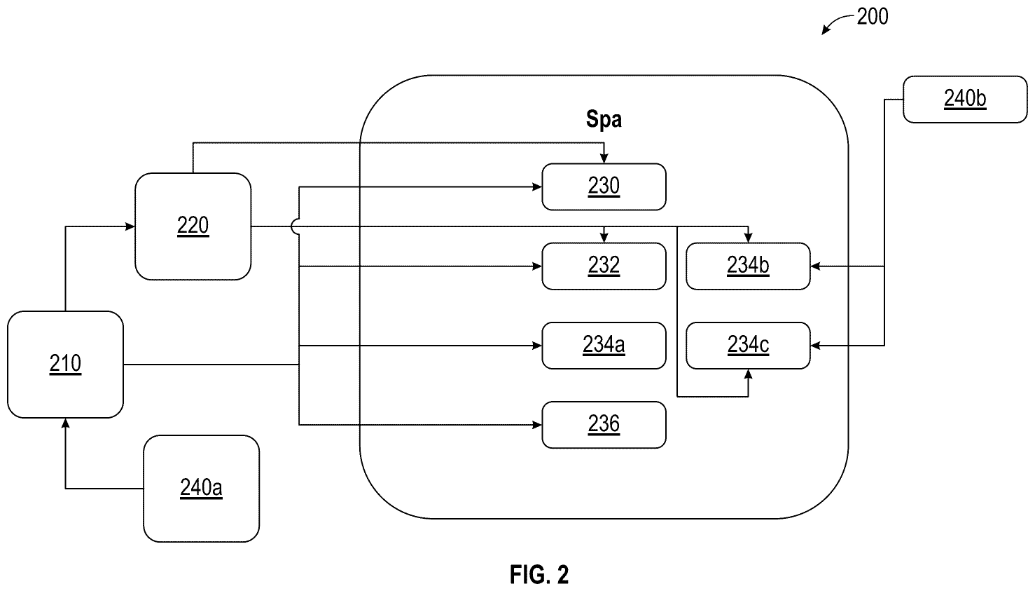

FIG. 2 shows a schematic view of a hybrid spa 200. In some cases, the hybrid spa 200 can include a power adapter 210 and one or more batteries 220. The power adapter 210 and the battery 220 can power one or more spa components of the hybrid spa 200.

The spa components can include one or more jet pump(s) 230, circulation pump(s) 232, a main heater 234a, one or more secondary heaters 234b, 234c, and/or controller(s) 236. Although reference is made to the spa 200 including two secondary heaters 234b, 234c, the spa 200 can include less than two or more than two secondary heaters. For example, the spa 200 can include one secondary heater, three secondary heaters, or six secondary heaters. In some cases, the spa 200 and its components can connected to and/or draw power from more than one power source. For example, the power adapter 210 can be plugged to a first power outlet 240a and the secondary heaters 234b, 234c can be plugged to a second power outlet 240b. The power adapter 210 can distribute power from the power outlet 240a to the plurality of spa components and the battery 220. The battery 220 and/or any of the spa components can draw power from the power adapter 210. For example, the battery 220 can draw power from the power adapter 210 to recharge. In some cases, the secondary heaters 234b, 234c can draw power from the second power outlet 240b. Beneficially, the hybrid spa 200 can be installed in any location having at least two 120 V power outlet and does not require a 240 V power outlet installation.

In any of the embodiments described herein, each of the spa components, including the one or more jet pump(s) 230, the circulation pump(s) 232, the main heater 234a, the one or more secondary heaters 234b, 234c, and/or the controller(s) 236, can be connected to at least one power source. Depending on the combined power requirement of the spa components, two or more of the spa components 130a-130d may draw power from different power sources. When, for example, the combined power requirement of a first spa component (e.g., the circulation pump 232) and a second spa component (e.g., the main heater 234a) exceeds a maximum load of a single power source (e.g., the power adapter 210), the first and second spa components may draw power from different power sources. For instance, the first spa component (e.g., the circulation pump 232) can draw power from the power adapter 210 while the second spa component (e.g., the secondary heater 234b) draws power from the second power outlet 240b. This can allow the combined power requirement of the spa components to be drawn from more than one source of power. This can beneficially prevent the spa components from overloading a single source of power.

In operation, the battery 220 can be recharged by drawing power from the power adapter 210. In some cases, the battery 220 can draw power from the power adapter 210 when, for example, none of the spa components are in use. The power adapter 210 and the battery 220 can supply power to the spa components. For example, the power adapter 210 can supply power to the jet pumps 230, the circulation pump 232, the main heater 234a, and/or the controller 236, and the battery 220 can supply power to the jet pumps 230, the circulation pump 232, and/or the secondary heaters 234b, 234c. In some cases, the power adapter 210 and the battery 220 can supply power to the same spa components simultaneously. The secondary heaters 234b, 234c can also draw power from the second power outlet 240b. In some cases, the spa 200 does not include a battery 220. In such cases, the secondary heaters 234b, 234c can draw power exclusively from the second power outlet 240b.

The use of the battery 220 and/or the second power outlet 240b for powering at least some of the spa components can beneficially prevent the hybrid spa 200 from overloading a single power outlet (e.g., a 120 V power outlet). For example, the power necessary to simultaneously power all, or more than one, of the spa components may overload a standard 120 V power outlet and cause the spa 200 to shut down and/or result in a fire. The load on a single power outlet can be reduced by powering at least a subset of the spa components with the battery 120 and/or the second power outlet 240b. For example, a charged battery 120 can power the one or more jet pumps 230, the circulation pump 232, and the secondary heaters 234b, 234c. In some cases, the secondary heaters 234b, 234c can also draw power from the second power outlet 240b. The power adapter 210 can power the main heater 234a and the spa controller 236. This can prevent the power adapter 210 from overloading the first power outlet 240a and allow users to operate the jet pumps 230, the circulation pump 232, the main heater 234a, and the secondary heaters 234b, 234c simultaneously. In some cases, the battery 220 can power the at least one of the spa components, for example, the jet pumps 230, when the main heater 234a is on. This can beneficially prevent the power adapter 210 from overloading the first power outlet 240a. The secondary heaters 234b, 234c can be smaller than the main heater 234a and can be used to heat the spa 200 when users are heating water from, for example, tap temperature, to about 100° F. to 104° F. In some cases, the secondary heaters 234b, 234c can be activated when a starting temperature of the water is being raised (e.g., when the water is being heated) by more than a predetermined temperature, for example at least 5° F. or more, or to at least a predetermined temperature (e.g., above 100° F.). Having the secondary heaters 234b, 234c draw power from a different power source than the power adapter 210 can prevent the power adapter 210 from overloading the first power outlet 240a while allowing simultaneous use of the main heater 234a and the secondary heaters 234b, 234c. The spa may not need to use the secondary heaters 234b, 234c all the time. For example, when water is not being heated from tap temperature, the spa 200 can heat the water to the user's desired temperature (e.g., 100° F., 101° F., 102° F., 104° F.) using only the main heater 234a. When not in use, the secondary heaters 234b, 234c can be unplugged from the second power outlet 240b and removed from the spa 200 for storage at a remote location.

The controller 236 can manage the power distribution of the spa components. The controller 236 can, in some cases, detect and/or anticipate a power overload and cause the spa components to draw power from a different power source. For example, using the main heater 234a, the secondary heaters 234b, 234c simultaneously can cause the spa 200 to overload a conventional 120 V power outlet, such as the first power outlet 240. To prevent a power overload, the controller 236 can cause the secondary heaters 234b, 234c, or any other spa component, to stop drawing power from the power adapter 210 and start drawing power from the battery 220. This can beneficially reduce the power drawn by the spa 200 from the first power outlet 240a, prevent a circuit overload when the main heater 234a and other components of the spa 200 are operating simultaneously, and/or expedite the heating process. For example, the use of secondary heaters 234b, 234c can shorten the heating process from about 24-72 hours using a 120 V power outlet, to about 10 or less hours. The controller 236 can cause the one or more spa components to alternate between different sources of power (e.g., the first power adapter 210 and/or the battery 220) as needed.

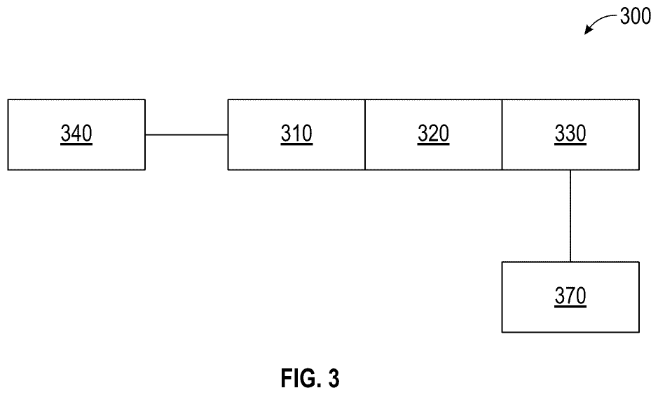

FIG. 3 shows an example of a battery system 300 for use with a hybrid spa, such as spa 100 to spa 200. Any of the batteries disclosed herein, such as battery 120 or battery 220, can be similar to battery system 300. The battery system 300 can include a battery charger 310, a battery 320, and an inverter 330 connected to each other. Optionally, not shown, the battery charger 310 can be external to the battery 320 and be positioned between a power source (e.g., power outlet 340) and the battery 320. The battery system 300 can be connected to a power outlet 340. The power outlet 340 can include a 120 V or a 240 V outlet. The battery charger 310 can draw power from the power outlet 340 to charge the battery 320. The battery 320 can be in communication with the inverter 330. The inverter 330 can facilitate conversion of the direct current (DC) of the battery 320 to alternating current (AC). In some cases, the spa components 370 can draw power from the battery system 300.

### Terminology

Although certain embodiments and examples are disclosed herein, inventive subject matter extends beyond the examples in the specifically disclosed embodiments to other alternative embodiments and/or uses, and to modifications and equivalents thereof. While we have described and illustrated in detail embodiments of a hybrid spa including a battery and a power adapter, it should be understood that our inventions can be modified in both arrangement and detail. For example, the features described herein can be incorporated into any type of spa or hot tub unit that may not be hybrid. Thus, the scope of the claims appended hereto is not limited by any of the particular embodiments described above. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

1.-46. (canceled)

47. A hybrid spa comprising:
a housing;
a rechargeable battery; and
a plurality of spa components configured to draw power from a first power outlet and/or the rechargeable battery; and
wherein the rechargeable battery is configured to recharge by drawing power from the first power outlet when the plurality of spa components are not in use.

48. The hybrid spa of claim 47, wherein each of the plurality of spa components is configured to draw power from only one of the first power outlet or the rechargeable battery.

49. The hybrid spa of claim 47, wherein each of the plurality of spa components is configured to draw power from the first power outlet and the rechargeable battery.

50. The hybrid spa of claim 47, wherein each of the plurality of spa components is configured to draw power at least from the first power outlet.

51. The hybrid spa of claim 47, wherein the plurality of spa components comprises a jet pump, a circulation pump, and a main heater, and wherein each of the jet pump, the circulation pump, and the main heater is configured to draw power at least from the first power outlet.

52. The hybrid spa of claim 51, further comprising a secondary heater configured to draw power from a second power outlet.

53. The hybrid spa of claim 52, further comprising a controller configured to manage power distribution to the plurality of spa components, wherein the controller is configured to activate both the main heater and the secondary heater when heating water by more than 5° F.

54. The hybrid spa of claim 47, further comprising an equipment bay within a footprint of the housing, wherein the rechargeable battery is positioned in the equipment bay.

55. The hybrid spa of claim 47, wherein the plurality of spa components comprises a first spa component and a second spa component, wherein the first spa component is configured to draw power from the first power outlet and the second spa component is configured to draw power from the rechargeable battery when a combined power requirement of the first and second spa components exceeds a maximum load of the first power outlet.

56. The hybrid spa of claim 55, wherein the first spa component comprises a main heater and wherein the second spa component comprises a secondary heater, and wherein the combined power requirement of the main heater and the secondary heater exceeds the maximum load of the first power outlet when heating water by more than 5° F.

57. The hybrid spa of claim 55, wherein the first spa component comprises a heater and the second spa component comprises a jet pump.

58. A hybrid spa comprising:
a rechargeable battery;
a heater configured to draw power from a first power outlet; and
a plurality of jet pumps configured to draw power from the first power outlet and/or the rechargeable battery;
wherein the heater is configured to draw power from the first power outlet and the plurality of jet pumps is configured to draw power from the rechargeable battery when both the heater and the plurality of jet pumps are in use.

59. The hybrid spa of claim 58, further comprising a controller configured to manage power distribution to the heater and the plurality of jet pumps.

60. The hybrid spa of claim 58, further comprising:
a controller configured to manage power distribution to the heater and the plurality of jet pumps; and
a secondary heater configured to draw power from a second power outlet;
wherein the controller is configured to activate both the heater and the secondary heater when heating water by more than 5° F.

61. The hybrid spa of claim 58, wherein the rechargeable battery recharges when the heater and the plurality of jet pumps are not in use.

62. The hybrid spa of claim 58, further comprising a housing and an equipment bay within a footprint of the housing, wherein the rechargeable battery is positioned in the equipment bay.

63. An electrical system for a spa, the electrical system comprising:
a rechargeable battery; and
at least one spa component configured to draw power from a first power outlet and/or the rechargeable battery; and
wherein the rechargeable battery is configured to recharge by drawing power from the first power outlet when the at least one spa component is not in use.

64. The electrical system of claim 63, wherein the at least one spa component comprises a first spa component and a second spa component, wherein at least one of the first and second spa components is configured to draw power from a second power source, and wherein the at least one of the first and second spa components configured to draw power from the second power source is configured to draw power from the second power source when a combined power requirement of the first and second spa components exceeds a maximum load of the first power outlet.

65. The electrical system of claim 64, wherein the first and second spa components are configured to draw power from the first power outlet and/or the rechargeable battery when the combined power requirement of the first and second spa components does not exceed the maximum load of the first power outlet.

66. The electrical system of claim 64, wherein the first spa component comprises a main heater and wherein the second spa component comprises a secondary heater, and wherein the combined power requirement of the main heater and the secondary heater exceeds the maximum load of the first power outlet when heating a starting temperature of water by at least 5° F.
